(19) United States
(12) Patent Application Publication
(10) Pub. No.: US 2024/0199375 A1
(43) Pub. Date: Jun. 20, 2024

(54) DEVICE AND METHOD FOR DETECTING SEAL STAR FUNCTION OF ELEVATOR SYSTEM

(71) Applicant: Otis Elevator Company, Farmington, CT (US)

(72) Inventors: Xingzhong Sun, Hangzhou (CN); Shan Li, Hangzhou (CN); Weilin Dai, Hangzhou (CN)

(21) Appl. No.: 18/449,430

(22) Filed: Aug. 14, 2023

(30) Foreign Application Priority Data
Dec. 20, 2022 (CN) 202211639562.1

(51) Int. Cl. B66B 5/00

(52) U.S. Cl. CPC B66B 5/0031

(57) ABSTRACT

A device and method for detecting a seal star function of an elevator system and readable storage medium on which a computer program for implementing the method is stored. The device for detecting a seal star function of an elevator system includes an elevator door bypass unit configured to enable power supply to an elevator motor and a holding brake when an elevator car is located in a set area and to cut off the power supply to the elevator motor and the holding brake when the elevator car leaves the set area; a control unit coupled with a safety relay and the elevator door bypass unit and configured to determine whether the seal star function is normal based on speed of movement of the elevator car within the set area.

### FOREIGN PRIORITY

This application claims priority to Chinese Patent Application No. 202211639562.1, filed Dec. 20, 2022, and all the benefits accruing therefrom under 35 U.S.C. § 119, the contents of which in its entirety are herein incorporated by reference.

### TECHNICAL FIELD

The present application relates to elevator safety technology, in particular to a device and method for detecting a seal star function of an elevator system and computer-readable storage medium on which a computer program for implementing the method is stored.

### BACKGROUND

When a holding brake fails in an elevator system, an elevator motor will slip in the direction of a light load. FIG. 1 shows a principle of implementing a seal star function within the elevator system. As shown in FIG. 1, three-phase outputs u, v and w of an inverter are connected to the elevator motor M via switches SW. When a car stops at a floor, the switches SW break and three phase wires of a seal star contactor FX are shorted to prevent the motor from slipping quickly, thus providing safety protection. In order to improve safety, the effectiveness of the seal star function needs to be detected regularly or irregularly. But so far, the industry has not provided a simple, reliable, safe and low-cost solution for detecting the seal star function.

### SUMMARY

According to an aspect of the present application, there is provided a device for detecting a seal star function of an elevator system, wherein the elevator system comprises a safety circuit for controlling power supply to an elevator motor and a holding brake, the safety circuit comprises a safety relay and a safety switch connected in series, the device comprising: an elevator door bypass unit configured to enable the power supply to the elevator motor when an elevator car is located in a set door area and to cut off the power supply to the elevator motor and the holding brake when the elevator car leaves the set door area; a control unit coupled with the safety relay and the elevator door bypass unit and configured to perform the following operations: placing a landing door and an elevator door associated with the safety switch in a closed state and placing the safety relay in an opened state; bringing the elevator door bypass unit into an enabled state to replace the safety circuit to perform a control function of the power supply to the elevator motor and the holding brake; determining whether the seal star function is normal based on speed of movement of the elevator car within the set door area.

Optionally, in the above device, the control unit is further configured to perform the following operations before placing the landing door and the elevator door associated with the safety switch in the closed state and placing the safety relay in the opened state: determining, based on preset conditions, whether to allow entry into a seal star function detection mode, wherein the preset conditions include one or more of the following items: current time is within a set period of time, a load of the elevator system is less than a set level, length of time the elevator car is in a stationary state exceeds a set length of time, and there is no call request at present; if it is allowed to entry into the seal star function detection mode, the elevator car is made to stop at a specified floor.

Optionally, in the above device, the set door area is the specified floor.

Optionally, in the above device, the control unit is a main control circuit board of the elevator system.

Optionally, in the above device, the control unit is configured to bring the elevator door bypass unit into the enabled state in the following manner: determining whether the safety relay is in the opened state by determining whether the safety circuit is in an opened state; if it is determined that the safety relay is in the opened state, bringing the elevator door bypass unit into the enabled state by sending it an enabling signal, otherwise generating a message about a fault in the safety relay; activating a holding brake function of the elevator system.

Optionally, in the above device, the device further comprises a speed measurement unit configured to measure a plurality of speed sample values of the elevator car at a set time interval.

Optionally, in the above device, the control unit is configured to determine whether the seal star function is normal in the following manner: determining a peak speed during a period when the elevator car is in a set range from the speed sample values; determining whether the seal star function is normal by comparing the peak speed with a set threshold, wherein the set threshold is determined based on a peak speed of the elevator car at the time the seal star function fails.

Optionally, in the above device, the peak speed determined from the speed sample values is an average of the speed sample values within a set interval centered on a maximum value of the speed sample values.

Optionally, in the above device, the peak speed determined from the speed sample values is a maximum value of the speed sample values.

Optionally, in the above device, the control unit is further configured to disconnect the power supply to the elevator motor and the holding brake when the seal star function is determined to be abnormal.

According to another aspect of the present application, there is provided a method for detecting a seal star function of an elevator system, wherein the elevator system comprises a safety circuit for controlling power supply to an elevator motor and a holding brake, the safety circuit comprises a safety relay and a safety switch connected in series, the method comprising: placing a landing door and an elevator door associated with the safety switch in a closed state and placing the safety relay in an opened state; bringing an elevator door bypass unit into an enabled state to replace the safety circuit to perform a control function of the power supply to the elevator motor and the holding brake, wherein the elevator door bypass unit is configured to enable the power supply to the elevator motor when an elevator car is located in a set door area and to cut off the power supply to the elevator motor and the holding brake when the elevator car leaves the set door area; measuring speed of movement of the elevator car within the set door area; and determining whether the seal star function is normal based on the measured speed of movement.

According to another aspect of the present application, there is provided a non-transitory computer-readable storage medium on which a computer program suitable for execution on a processor of a terminal device is stored, the execution of the computer program causing the steps of the method as described above to be performed.

### DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1 shows a principle of implementing a seal star function within an elevator system.

FIG. 2 is a schematic diagram of a device for detecting a seal star function of an elevator system in accordance with some embodiments of the present application.

FIG. 3 shows a principle of operation of the device for detecting a seal star function of an elevator system shown in FIG. 2.

FIG. 4 is a flowchart of a method for detecting a seal star function of an elevator system in accordance with some other embodiments of the present application.

FIG. 5 is a flowchart of a method for bringing an elevator door bypass unit into an enabled state in accordance with some other embodiments of the present application.

FIG. 6 is a flowchart of a method for determining whether the seal star function is normal in accordance with some other embodiments of the present application.

### DETAILED DESCRIPTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

In the specification of the application, the term “safety circuit” refers to a circuit where various electrical safety switches are connected in series to control power supply to an elevator motor and a holding brake. In some examples, the safety circuit includes safety switches connected in series to indicate closed state and opened state of a landing door and an elevator door. When there is an opened landing door or elevator door, the corresponding safety switch is opened to disconnect the power supply to the elevator motor and the holding brake.

In some embodiments of the application, a safety relay is also connected in series within a door lock circuit of the safety circuit. The safety relay is opened when the seal star function is activated, simulating the door lock circuit to be opened, and in fact the hall door and car door are in a closed state. On the other hand, an elevator door bypass unit is brought into an enabled state to bypass the door lock circuit to perform the control of the power supply to the elevator motor and the holding brake.

It should be noted that the safety relay can be connected in series at any position in the door lock circuit, for example, next to the safety switch associated with the landing door or the elevator door at the nth floor.

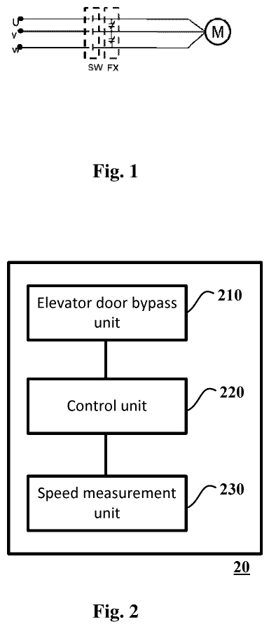

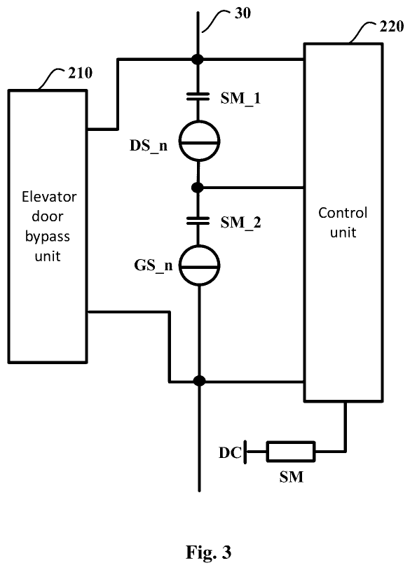

FIG. 2 is a schematic diagram of a device for detecting a seal star function of an elevator system in accordance with some embodiments of the present application. FIG. 3 shows a principle of operation of the device for detecting a seal star function of an elevator system shown in FIG. 2.

A device 20 shown in FIG. 2 includes an elevator door bypass unit 210 and a control unit 220. Optionally, but not necessarily, the device 20 may also include a speed measurement unit 230 for measuring speed of movement of the elevator car.

The elevator door bypass unit 210 may control the power supply to the elevator motor and the holding brake based on the position of a door area of the elevator car, thereby limiting the movement of the elevator car within a set door area to avoid loss of control. In particular, the elevator door bypass unit 210 may be configured to enable the power supply to the elevator motor and the holding brake when the elevator car is located in the set door area and to cut off the power supply to the elevator motor and the holding brake when the elevator car leaves the set door area. Exemplarily, the set door area described herein may be a specified floor.

The control unit 220 is coupled with the elevator door bypass unit 210, and the two cooperate to perform detection of the seal star function. Optionally, the control unit 220 may be a main control circuit board of the elevator system.

The detection of the seal star function is described in detail below in connection with FIG. 3.

It should be understood that FIG. 3 shows only one section of a safety circuit 30, which (hereinafter referred to as circuit section A) comprises safety switches DS_n and GS_n corresponding to or associated with the landing door and the elevator door at the nth floor, respectively. In the example shown in FIG. 3, a safety relay SM comprises two contacts SM_1 and SM_2 connected in series within the safety circuit 30.

Continuing with FIG. 3, the safety switches DS_n and GS_n and contacts SM_1 and SM_2 of the safety relay SM are connected in series to form the circuit section A. The elevator door bypass unit 210 is connected in parallel at both ends of the circuit section A to bypass the circuit section A when the seal star function is detected, thereby replacing the safety circuit 30 to perform a control function of the power supply to the elevator motor and the holding brake. The control unit 220 is coupled with the safety relay SM to control the states of the relay contacts. For example, in the example of FIG. 3, the control unit 220 may achieve control of the states of the contacts SM_1 and SM_2 by controlling the power supply to the safety relay SM. In addition, the control unit 220 monitors the circuit states at a plurality of nodes within the safety circuit 30, such as the nodes identified by black dots in FIG. 3.

In some embodiments, the control unit 220 may be configured to perform the detection of the seal star function in accordance with the following:

At first, the landing door and the elevator door associated with the safety switches DS_n and GS_n are made closed and the contacts SM_1 and SM_2 of the safety relay SM are made open. Subsequently, for example, by sending an enable signal to the elevator door bypass unit 210, the elevator door bypass unit 210 is brought into the enabled state to bypass the safety circuit 30 to perform the control function of the power supply to the elevator motor and the holding brake. Then, it is determined whether the seal star function is normal based on the speed of movement of the elevator car within the set door area.

Optionally, the control unit 220 is also configured to disconnect the power supply to the elevator motor and the holding brake to avoid safety hazards if the seal star function is determined to be abnormal.

In some embodiments, the control unit 220 determines whether the seal star function is normal in the following manner:

At first, a peak speed Vₚₑₐₖ during the period when the elevator car is in a set range is determined from a plurality of speed sample values V₁, V₂ . . . V_{N}. The speed sample values V₁, V₂ . . . V_{N} may for example be measured by the speed measurement unit 230 at a set time interval. Optionally, the above peak speed V peak is an average of the speed sample values within the following set interval, which is centered on a maximum value Vₘₐₓ of the speed sample values. Optionally, the above peak speed Vₚₑₐₖ is the maximum value Vₘₐₓ of the speed sample values.

Subsequently, the determined peak speed Vₚₑₐₖ is compared with a set threshold TH to determine whether the seal star function is normal. For example, if the peak speed Vₚₑₐₖ is greater than or equal to the threshold TH, it is determined that the seal star function is abnormal, otherwise, it is determined that the seal star function is normal. Optionally, the above threshold may be determined based on the peak speed V_ERRₚₑₐₖ of the elevator car at the time the seal star function fails (e.g., the peak speed V_ERRₚₑₐₖ of the elevator car at the time the seal star function fails is reduced by a certain percentage and then the reduce peak speed is taken as the threshold TH).

Since the limit function of the elevator door bypass unit can be used to avoid loss of control of elevator car movement, safety during the detection of the seal star function is improved. In addition, for existing elevator systems, both the circuit bypass unit and the control unit are standard components, so it is only necessary to add the safety relay in the safety circuit and upgrade the operating control software to implement the detection of the seal star function in the manner described above, which is beneficial for reducing costs and development time.

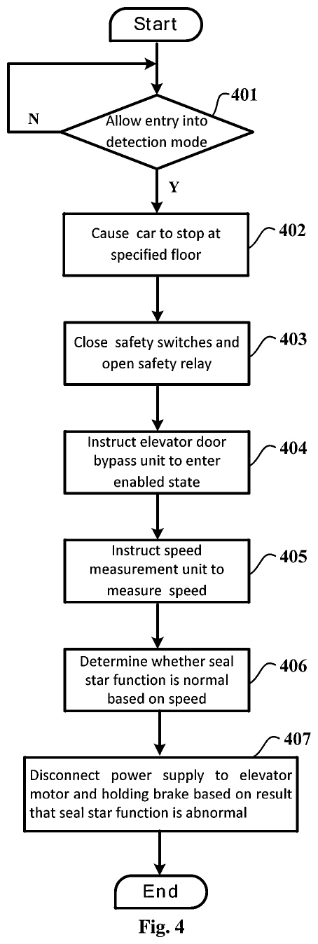

FIG. 4 is a flowchart of a method for detecting a seal star function of an elevator system in accordance with some other embodiments of the present application. Exemplarily, the method described below is implemented with the help of the device shown in FIG. 2.

The method flow shown in FIG. 4 begins at step 401. In this step, the control unit 220 determines whether to allow entry into a seal star function detection mode based on preset conditions, and if so, proceeds to step 402, otherwise, continues to wait. The preset conditions described herein include, for example, but are not limited to: current time is within a set period of time (e.g. 1:00 am to 3:00 am), a load of the elevator system is less than a set level (e.g. no load), length of time the elevator car is in a stationary state exceeds a set length of time (e.g. 5 minutes), and there is no call request at present (e.g. including outcall request and incall request), etc.

At step 402, the control unit 220 causes the elevator car to stop at the specified floor (e.g. 2nd floor or sub-top floor).

After performing step 402, the method flow shown in FIG. 4 moves to step 403. In this step, the landing door and the elevator door associated with the safety switches (e.g., safety switches DS_n and GS_n) are closed and the safety relay (e.g., the contacts SM_1 and SM_2 of the safety relay SM) is made open under the control of the control unit 220.

Subsequently proceeding to step 404, the control unit 220 instructs the elevator door bypass unit 210 to enter the enabled state to replace the safety circuit 30 to perform a control function of the power supply to the elevator motor.

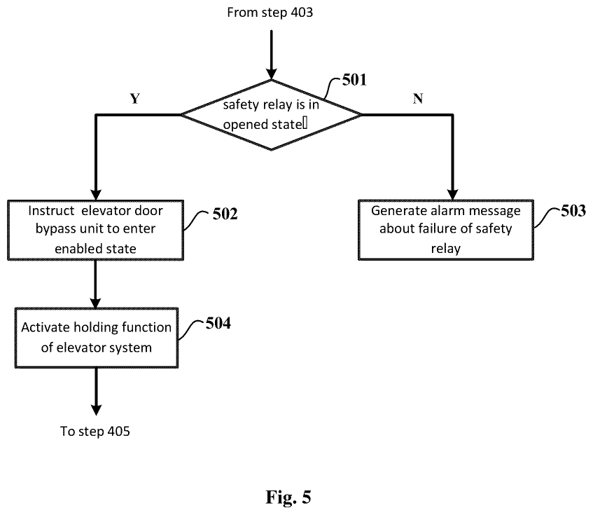

In some embodiments, the elevator door bypass unit may be brought into the enabled state in the manner shown in FIG. 5.

As shown in FIG. 5, at step 501, the control unit 220 determines whether the safety relay SM is in an opened state, and if so, proceeds to step 502, otherwise proceeds to step 503. In step 501, this may be done, for example, by monitoring the circuit states at one or more nodes within the circuit section A. In particular, if the circuit state at the node is open, it may be determined that the safety relay SM is in the opened state, which indicates that the safety relay is working normally; on the other hand, if the circuit state at the node is closed, it may be determined that the safety relay SM is in the closed state, which indicates that the safety relay is working abnormally.

In step 502, the control unit 220 instructs the elevator door bypass unit 210 to enter the enabled state (e.g., by sending an enable signal to the elevator door bypass unit 210).

After performing step 502, the method flow shown in FIG. 5 proceeds to step 504. In this step, the control unit 220 activates the holding function of the elevator system.

Returning to another branch of step 501, step 503. In this step, the control unit 220 will generate an alarm message about the failure of the safety relay.

Continuing with FIG. 4, after performing step 404, the method flow shown goes to step 405. In this step, the control unit 220 instructs the speed measurement unit 230 to measure the speed of movement of the elevator car, for example at a set time interval. As a result, the speed measurement unit will measure a plurality of speed sample values V₁, V₂ . . . V_{N} when the elevator car is moving in the set door area. At the same time, the elevator door bypass unit 210 will monitor whether the elevator car is located in the set door area, and if it is located in the set door area, enable the power supply to the elevator motor and the holding brake, otherwise, cut off the power supply to the elevator motor and the holding brake. After performing step 405, the method flow shown in FIG. 4 proceeds to step 406. In this step, the control unit 220 will determine whether the seal star function is normal based on the speed of movement measured by the speed measurement unit 230.

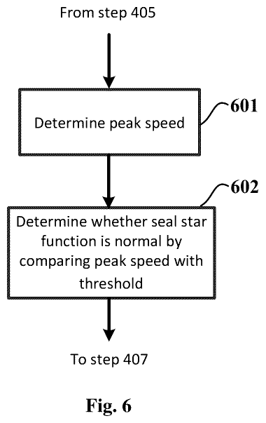

In some embodiments, it is possible to determine whether the seal star function is normal or not in the manner shown in FIG. 6.

As shown in FIG. 6, at step 601, the control unit 220 determines a peak speed Vₚₑₐₖ during the period when the elevator car is in a set range from the plurality of speed sample values V₁, V₂ . . . V_{N}. As described above, the peak speed Vₚₑₐₖ may be an average of the speed sample values within the following set interval, which is centered on a maximum value Vₘₐₓ of the speed sample values, or the peak speed Vₚₑₐₖ may be the maximum value Vₘₐₓ of the speed sample values.

This is followed by step 602. In this step, the control unit 220 determines whether the seal star function is normal by comparing the peak speed Vₚₑₐₖ with a set threshold TH. For example, if the peak speed Vₚₑₐₖ is greater than or equal to the threshold TH, it is determined that the seal star function is abnormal, otherwise, it is determined that the seal star function is normal. As described above, the set threshold may be determined based on the peak speed of the elevator car at the time the seal star function fails.

Continuing with FIG. 4, after performing step 406, the method flow moves to step 407. In this step, the control unit 220 disconnects the power supply to the elevator motor and the holding brake based on the result of the determination in step 406 that the seal star function is abnormal.

In accordance with another aspect of the present application, there is also provided a non-transitory computer-readable storage medium on which a computer program is stored which, when executed by a processor, can implement one or more steps contained in the method described above with the aid of FIGS. 4-6.

The computer-readable storage medium referred to in the application includes various types of computer storage media, and may be any available medium that may be accessed by a general-purpose or special-purpose computer. For example, the computer-readable storage medium may include RAM, ROM, EPROM, E2PROM, registers, hard disks, removable disks, CD-ROM or other optical disk storage, magnetic disk storage or other magnetic storage devices, or any other transitory or non-transitory medium that may be used to carry or store a desired program code unit in the form of instructions or data structures and that may be accessed by a general-purpose or special-purpose computer or a general-purpose or special-purpose processor. The above combination should also be included in the protection scope of the computer-readable storage medium. An exemplary storage medium is coupled to the processor such that the processor can read and write information from and to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

Those skilled in the art will appreciate that the various illustrative logical blocks, units, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A device for detecting a seal star function of an elevator system, wherein the elevator system comprises a safety circuit for controlling power supply to an elevator motor and a holding brake, the safety circuit comprises a safety relay and a safety switch connected in series, the device comprising:
an elevator door bypass unit configured to enable the power supply to the elevator motor and the holding brake when an elevator car is located in a set door area and to cut off the power supply to the elevator motor and the holding brake when the elevator car leaves the set door area;
a control unit coupled with the safety relay and the elevator door bypass unit and configured to perform the following operations:
placing a landing door and an elevator door associated with the safety switch in a closed state and placing the safety relay in an opened state;
bringing the elevator door bypass unit into an enabled state to replace the safety circuit to perform a control function of the power supply to the elevator motor and the holding brake;
determining whether the seal star function is normal based on speed of movement of the elevator car within the set door area.

2. The device of claim 1, wherein the control unit is further configured to perform the following operations before placing the landing door and the elevator door associated with the safety switch in the closed state and placing the safety relay in the opened state:
determining, based on preset conditions, whether to allow entry into a seal star function detection mode, wherein the preset conditions include one or more of the following items: current time is within a set period of time, a load of the elevator system is less than a set level, length of time the elevator car is in a stationary state exceeds a set length of time, and there is no call request at present;
if it is allowed to entry into the seal star function detection mode, the elevator car is made to stop at a specified floor.

3. The device of claim 1, wherein the set door area is the specified floor.

4. The device of claim 3, wherein the control unit is a main control circuit board of the elevator system.

5. The device of claim 4, wherein the control unit is configured to bring the elevator door bypass unit into the enabled state in the following manner:
determining whether the safety relay is in the opened state by determining whether the safety circuit is in an opened state;
if it is determined that the safety relay is in the opened state, bringing the elevator door bypass unit into the enabled state by sending it an enabling signal, otherwise generating a message about a fault in the safety relay;
activating a holding brake function of the elevator system.

6. The device of claim 3, wherein the device further comprises a speed measurement unit configured to measure a plurality of speed sample values of the elevator car at a set time interval.

7. The device of claim 6, wherein the control unit is configured to determine whether the seal star function is normal in the following manner:
determining a peak speed during a period when the elevator car is in a set range from the speed sample values;
determining whether the seal star function is normal by comparing the peak speed with a set threshold, wherein the set threshold is determined based on a peak speed of the elevator car at the time the seal star function fails.

8. The device of claim 7, wherein the peak speed determined from the speed sample values is an average of the speed sample values within a set interval centered on a maximum value of the speed sample values.

9. The device of claim 7, wherein the peak speed determined from the speed sample values is a maximum value of the speed sample values.

10. The device of claim 1, wherein the control unit is further configured to disconnect the power supply to the elevator motor and the holding brake when the seal star function is determined to be abnormal.

11. A method for detecting a seal star function of an elevator system, wherein the elevator system comprises a safety circuit for controlling power supply to an elevator motor and a holding brake, the safety circuit comprises a safety relay and a safety switch connected in series, the method comprising:
placing a landing door and an elevator door associated with the safety switch in a closed state and placing the safety relay in an opened state;
bringing an elevator door bypass unit into an enabled state to replace the safety circuit to perform a control function of the power supply to the elevator motor and the holding brake, wherein the elevator door bypass unit is configured to enable the power supply to the elevator motor and the holding brake when an elevator car is located in a set door area and to cut off the power supply to the elevator motor and the holding brake when the elevator car leaves the set door area;
measuring speed of movement of the elevator car within the set door area; and
determining whether the seal star function is normal based on the measured speed of movement.

12. The method of claim 11, wherein the method further comprises the steps of, before placing the landing door and the elevator door in the closed state and placing the safety relay in the opened state:
determining, based on preset conditions, whether to allow entry into a seal star function detection mode, wherein the preset conditions include one or more of the following items: current time is within a set period of time, a load of the elevator system is less than a set level, length of time the elevator car is in a stationary state exceeds a set length of time, and there is no call request at present;
if it is allowed to entry into the seal star function detection mode, the elevator car is made to stop at a specified floor.

13. The method of claim 11, wherein the set door area is the specified floor.

14. The method of claim 13, wherein the step of bringing the elevator door bypass unit into the enabled state comprises:
determining whether the safety relay is in the opened state;
if it is determined that the safety relay is in the opened state, bringing the elevator door bypass unit into the enabled state;
activating a holding brake function of the elevator system.

15. The method of claim 13, wherein the step of measuring speed of movement of the elevator car within the set door area comprises:
measuring the speed of movement of the elevator car at a set time interval to obtain a plurality of speed sample values.

16. The method of claim 15, wherein the step of determining whether the seal star function is normal based on the measured speed of movement comprises:
determining a peak speed during a period when the elevator car is in a set range from the speed sample values;
determining whether the seal star function is normal by comparing the peak speed with a set threshold, wherein the set threshold is determined based on a peak speed of the elevator car at the time the seal star function fails.

17. The method of claim 16, wherein the peak speed determined from the speed sample values is an average of the speed sample values within a set interval centered on a maximum value of the speed sample values.

18. The method of claim 16, wherein the peak speed determined from the speed sample values is a maximum value of the speed sample values.

19. The method of claim 11, wherein further comprising the steps of:
disconnecting the power supply to the elevator motor and the holding brake if the seal star function is determined to be abnormal.

20. A non-transitory computer-readable storage medium having instructions stored in the computer-readable storage medium, when the instructions are executed by a processor, the processor is caused to execute the method of claim 11.
